(19) United States
(12) Patent Application Publication
(10) Pub. No.: US 2024/0042594 A1
(43) Pub. Date: Feb. 8, 2024

(54) MOTION ASSIST APPARATUS

(71) Applicant: Agency for Defense Development, Daejeon (KR)

(72) Inventors: Myunghyun LEE, Daejeon (KR); Gwang Tae KIM, Daejeon (KR); Man Bok HONG, Daejeon (KR); Young June SHIN, Daejeon (KR); Yongcheol KIM, Daejeon (KR); Hanseung WOO, Daejeon (KR); Seonwoo KIM, Daejeon (KR)

(73) Assignee: Agency for Defense Development, Daejeon (KR)

(21) Appl. No.: 18/145,321

(22) Filed: Dec. 22, 2022

(30) Foreign Application Priority Data
Aug. 4, 2022 (KR) 10-2022-0097077

(51) Int. Cl. B25J 9/00; A61H 3/00; B25J 9/16; B25J 17/00

(52) U.S. Cl. CPC B25J 9/0006; A61H 3/00; B25J 9/0015; B25J 9/1694; B25J 17/00; A61H 2201/165; A61H 2003/007; A61H 2201/1642

(57) ABSTRACT

A motion assist apparatus is provided. The motion assist apparatus may include a proximal support configured to support a proximal part of a user, a distal support configured to support a distal part of the user, a proximal joint part rotatably connected to the proximal support around a first axis and a second axis perpendicular to the first axis, a distal joint part rotatably connected to the distal support around a third axis parallel to the second axis, and a connector configured to connect the proximal joint part and the distal joint part and movably connected to the distal joint part in a first direction perpendicular to the second axis and the third axis. There may be other additional example embodiments.

### CROSS-REFERENCE TO RELATED APPLICATION

This application claims the benefit of Korean Patent Application No. 10-2022-0097077 filed on Aug. 4, 2022, at the Korean Intellectual Property Office, the entire disclosure of which is incorporated herein by reference for all purposes.

### BACKGROUND

### 1. Field of the Invention

One or more example embodiments relate to a motion assist apparatus.

### 2. Description of the Related Art

Average life expectancy has increased, and a growing number of people are complaining of pain and discomfort in their joints while walking. Accordingly, there is a heightened interest in motion assist apparatuses for assisting the elderly and infirm or patients having joint problems.

Motion assist apparatuses may be worn on the body of a user and assist a gait cycle of the user by operating according to the movement of joints of the user. For example, a motion assist apparatus may transmit power such that the body of a user moves according to the movement of joints according to a gait cycle of the user. A motion assist apparatus may need to implement a natural motion so as not to obstruct a gait cycle of a user and have a simple and lightweight structure.

In this regard, Korean Patent Application Publication No. 10-2008-0034499 discloses “motion guide device, and its control system and control program”.

The above description is information the inventor(s) acquired during the course of conceiving the present disclosure, or already possessed at the time, and was not necessarily publicly known before the present application was filed.

### SUMMARY

Example embodiments provide a motion assist apparatus for assisting a gait of a user.

Example embodiments provide a motion assist apparatus for assisting a motion in an adduction or abduction direction of a human body according to a motion of a hip joint of a user.

Example embodiments provide a motion assist apparatus for assisting a gait cycle of a user and implementing a natural movement of a hip joint.

According to an aspect, there is provided a motion assist apparatus including a proximal support configured to support a proximal part of a user, a distal support configured to support a distal part of the user, a proximal joint part rotatably connected to the proximal support around a first axis and a second axis perpendicular to the first axis, a distal joint part rotatably connected to the distal support around a third axis parallel to the second axis, and a connector configured to connect the proximal joint part and the distal joint part and movably connected to the distal joint part in a first direction perpendicular to the second axis and the third axis.

The proximal joint part may include a slider member connected to the proximal support, a first rotation member disposed on the slider member and rotatably connected to the slider member around the first axis, and a second rotation member configured to connect the first rotation member and the connector such that the connector is rotatable around the second axis with respect to the first rotation member. The slider member may include a sliding surface formed on a surface on which the first rotation member is disposed and configured to guide a rotational motion of the connector with respect to the proximal joint part.

The connector may include a slider to be in contact with the sliding surface, and the slider may be configured to guide a first rotational motion of the connector around the first axis and a second rotational motion of the connector around the second axis while being in contact with the sliding surface.

The slider may be configured to limit a rotation angle of the connector such that the connector is in contact with the sliding surface and unable to rotate by an angle greater than or equal to a set angle while the connector is rotating around the second axis with respect to the proximal joint part, and the connector may be configured to generate a torque in a direction opposite to a rotational direction of the connector in response to rotating by the angle greater than or equal to the set angle.

The sliding surface may be formed such that a surface of the slider member is concave in a direction opposite to a surface on which the first rotation member is disposed, and the slider may be in point-contact with the sliding surface.

The connector may be configured to assign a degree of freedom in an abduction direction of the proximal part in response to a proximal part of the user moving in the abduction direction.

The distal part may include a third rotation member rotatably connected to the distal support around the third axis and a receiving member connected to the third rotation member and connected to the connector such that the connector is movable in the first direction.

The receiving member may include a guide space formed in the first direction, and at least a portion of the connector may be inserted into the guide space and may be slidable in the first direction in the guide space.

The proximal support may be disposed on a hip joint part of the user, the distal support may be disposed on a thigh of the user, and the first axis may penetrate a hip joint of the user based on a state in which the user is viewed from a side.

The first rotation member may be configured to rotate around the first axis in response to a flexion motion and an extension motion of a hip joint of the user, and the second rotation member may be configured to rotate around the second axis in response to an adduction motion and an abduction motion of the hip joint of the user.

The connector may be formed of an elastic body.

The motion assist apparatus may further include a sensor configured to sense a gait cycle of the user, an actuator configured to supply power such that the proximal joint part rotates with respect to the proximal support, and a controller configured to control an operation of the actuator based on information sensed by the sensor.

According to another aspect, there is provided a motion assist apparatus including a proximal support worn around a waist of a user, a distal support worn around a thigh of the user, a proximal joint part connected to the proximal support and configured to rotate in response to a motion of a hip joint of the user, a distal joint part rotatably connected to the distal support, and a connector rotatably connected to the proximal joint part and movably connected to the distal joint part in a longitudinal direction.

The proximal joint part may be rotatably connected to the proximal support in an adduction direction or an abduction direction with respect to the hip joint of the user.

The proximal joint part may be rotatably connected to the proximal support in a flexion direction or an extension direction with respect to the hip joint of the user.

Additional aspects of example embodiments will be set forth in part in the description which follows and, in part, will be apparent from the description, or may be learned by practice of the disclosure.

A motion assist apparatus according to an example embodiment may assist a gait of a user.

According to an example embodiment, a motion assist apparatus may assist an adduction or abduction motion of a hip joint of a user through a two degrees of freedom rotational motion of a proximal joint part with respect to a proximal support of the user.

The motion assist apparatus according to an example embodiment may provide a power assist in a gait period when a power assist is needed and thereby assist a gait of a user in a way that does not interfere with the gait of the user in a gait period when a power assist is not needed.

The effects of the motion assist apparatus according to one example embodiment are not limited to the above-mentioned effects, and other unmentioned effects can be clearly understood from the following description by one of ordinary skill in the art.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1A through 1C are diagrams illustrating a motion of a hip joint of a user;

FIG. 2A is a front view of a user wearing a motion assist apparatus according to an example embodiment;

FIG. 2B is a side view of a user wearing a motion assist apparatus according to an example embodiment;

FIG. 3 is a perspective view of a motion assist apparatus according to an example embodiment;

FIG. 4 is an enlarged view of a proximal joint part according to an example embodiment;

FIG. 5 is an enlarged view of a distal joint part according to an example embodiment;

FIG. 6A illustrates a motion of a motion assist apparatus according to an abduction motion of a hip joint according to an example embodiment;

FIG. 6B illustrates a motion of a motion assist apparatus according to an adduction motion of a hip joint according to an example embodiment;

FIG. 6C illustrates a motion of a motion assist apparatus according to a flexion/extension motion of a hip joint in the state of FIG. 6B; and

FIG. 7 is a block diagram illustrating a motion mechanism of a motion assist apparatus according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions of the examples may be applicable to the following examples and thus, duplicated descriptions will be omitted for conciseness.

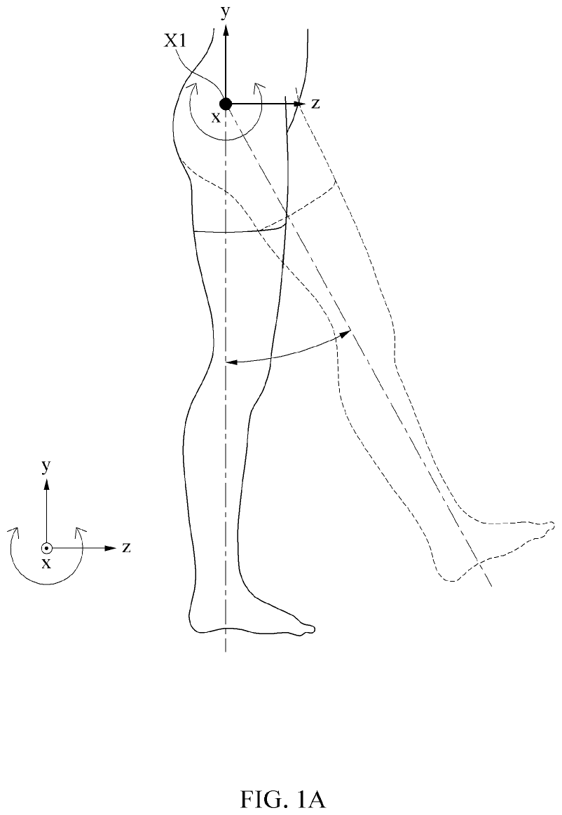

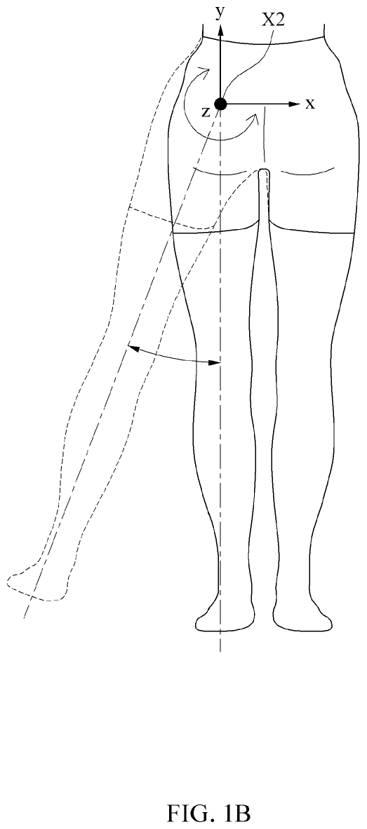

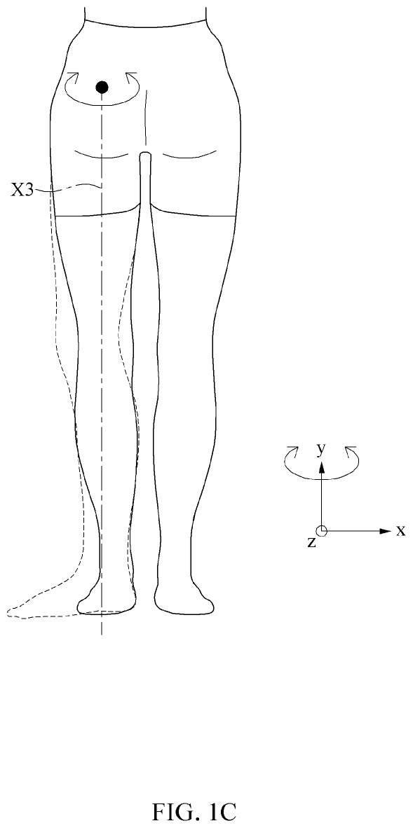

FIGS. 1A through 1C are diagrams illustrating a motion of a hip joint of a human. Specifically, FIG. 1A is a diagram illustrating a flexion/extension motion of a hip joint, FIG. 1B is a diagram illustrating an adduction/abduction motion of a hip joint, and FIG. 1C is a diagram illustrating a medial rotation/lateral rotation motion of a hip joint.

Referring to FIGS. 1A through 1C, a hip joint of a human may be understood as a ball joint capable of performing a three degrees of freedom rotational motion. A hip joint of a user may allow a thigh of the user to move with the three degrees of freedom rotational motion with respect to a waist of the user. A flexion/extension axis X1, an adduction/abduction axis X2, and a medial rotation/lateral rotation axis X3 are rotation axes according to a flexion/extension motion, an adduction/abduction motion, and a medial rotation/lateral rotation of the hip joint, respectively, while the user is standing upright. The three rotational motions of the hip joint may occur simultaneously. For example, the hip joint may perform a circumduction motion in which the adduction/abduction motion and the flexion/extension motion occur simultaneously. When the hip joint rotates around any one of the respective axes X1, X2, and X3, positions or angles of the other axes may change. Therefore, positions or angles or the respective axes may need to be changed in response to the above-described circumduction motion to properly assist a motion of a joint of the user.

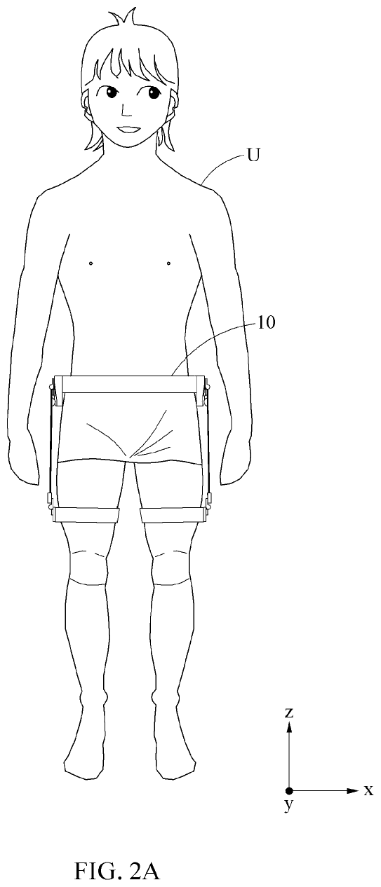

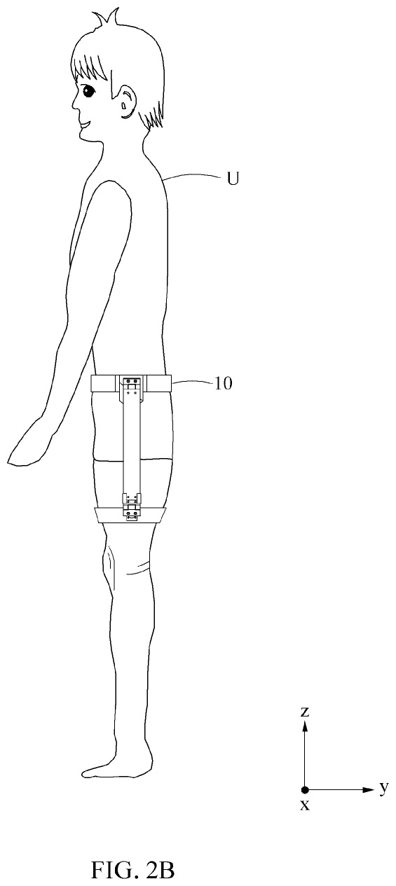

FIG. 2A is a front view of a user wearing a motion assist apparatus according to an example embodiment. FIG. 2B is a side view of a user wearing a motion assist apparatus according to an example embodiment.

Referring to FIGS. 2A and 2B, according to an example embodiment, a motion assist apparatus 10 may be worn on a body of a human and assist a motion of the human. Hereinafter, “user” refers to a human wearing the motion assist apparatus 10. FIGS. 2A and 2B illustrate examples in which the motion assist apparatus 10 according to an example embodiment assists a motion of the hip joint of the user. However, the motion assist apparatus 10 may assist other upper body parts of the user, such as a wrist, an elbow, or a shoulder, or other lower body parts of the user, such as an ankle or a knee. In other words, the motion assist apparatus 10 may assist a motion of any joint of the body of a user. Hereinafter, an example in which the motion assist apparatus 10 assists a motion of a hip joint of a user is described.

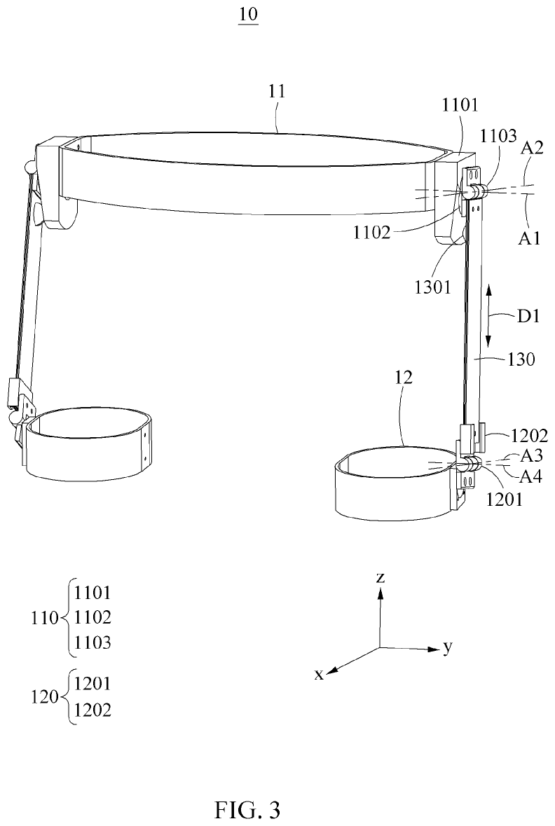

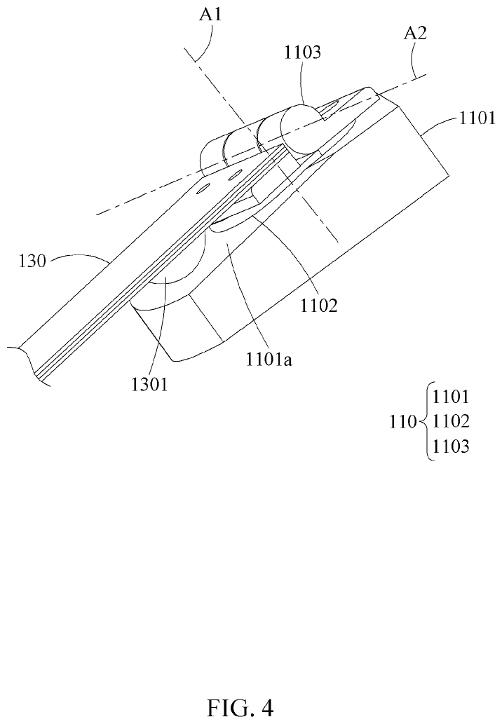

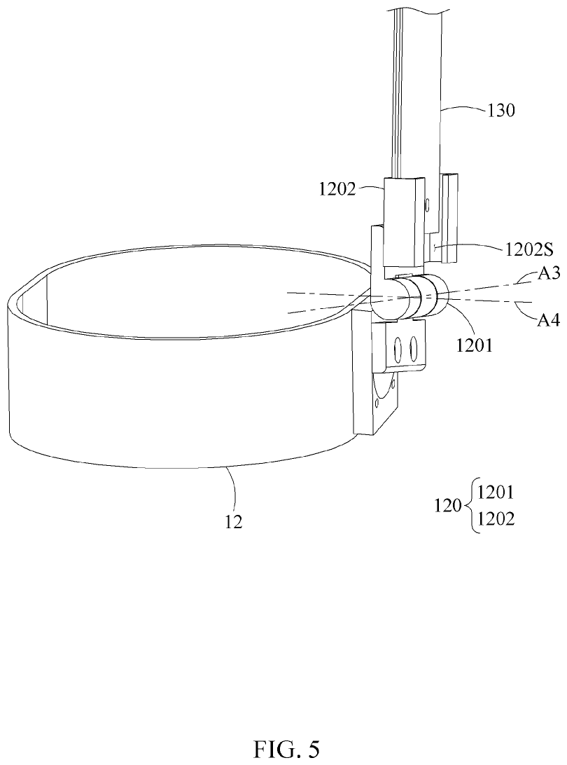

FIG. 3 is a perspective view of a motion assist apparatus according to an example embodiment, FIG. 4 is an enlarged view of a proximal joint part according to an example embodiment, and FIG. 5 is an enlarged view of a distal joint part according to an example embodiment.

Referring to FIGS. 3 through 5, according to an example embodiment, the motion assist apparatus 10 may include a proximal support 11 that supports a proximal part of a user, a distal support 12 that supports a distal part of the user, a proximal joint part 110 that is rotatably connected to the proximal support 11, a distal joint part 120 that is rotatably connected to the distal support 12, and a connector 130 that connects the proximal joint part 110 and the distal joint part 120.

In an example embodiment, the proximal support 11 and the distal support 12 may be opposite to each other based on a joint of the user and respectively support a proximal part and a distal part of the user. For example, when the motion assist apparatus 10 assists a motion of a hip joint of the user, the proximal support 11 may support a waist, a pelvis, or a body part adjacent to the hip joint of the user, and the distal support 12 may support body parts of the user opposite to the proximal support 11 with the hip joint as a center, such as a thigh, a knee, a calf, or a foot. In an example embodiment, the proximal support 11 and the distal support 12 may be worn on a body of the user. For example, the proximal support 11 may include a detachable belt to be worn around a waist of the user. For example, the distal support 12 may include a detachable belt to be worn around a thigh of the user.

In an example embodiment, the proximal joint part 110 may be connected to the proximal support 11. For example, the proximal support 110 may be connected to the proximal support 11 to be positioned on a side (e.g., the side of the user illustrated in FIG. 2B) of the user. In an example embodiment, the proximal joint part 110 may rotate relative to the proximal support 11. For example, the proximal joint part 110 may be connected to the proximal support 11 to have a multiple degrees of freedom rotational motion. In an example embodiment, a rotational motion of the proximal joint part 110 with respect to the proximal support 11 may be performed in response to the motion of the hip joint of the user. In an example embodiment, the proximal joint part 110 may rotate around a first axis A1 with respect to the proximal support 11. In this example, the rotational motion of the proximal joint part 110 around the first axis A1 may be performed in response to a flexion/extension motion of the hip joint of the user. In an example embodiment, the first axis A1 may penetrate the body of the user in a lateral direction (e.g., an x-axis direction of FIG. 2B) while the motion assist apparatus 10 is being worn on the body of the user. In an example embodiment, the first axis A1 may penetrate the hip joint of the user. In this example, the first axis A1 may coincide with a flexion/extension axis (e.g., the flexion/extension axis X1 of FIG. 1A) of the hip joint.

In an example embodiment, the proximal joint part 110 may rotate around a second axis A2 perpendicular to the first axis A1 with respect to the proximal support 11. In this example, a rotational motion of the proximal joint part 110 around the second axis A2 may be performed in response to an adduction/abduction motion of the hip joint of the user. In an example embodiment, the second axis A2 may be parallel to an axis that penetrates from a front to a rear of the user while the motion assist apparatus 10 is being worn on the body of the user. For example, the second axis A2 may be parallel to the adduction/abduction axis (e.g., the adduction/abduction axis X2 of FIG. 1B) of the hip joint.

In an example embodiment, the proximal joint part 110 may implement a two degrees of freedom rotational motion with respect to the proximal support 11 by rotating around at least one of the first axis A1 and the second axis A2 with respect to the proximal support 11. In an example embodiment, the proximal joint part 110 may assist the motion of the hip joint by rotating with respect to the proximal support 11 according to the flexion/extension motion and the adduction/abduction motion of the hip joint. In an example embodiment, the proximal joint part 110 may include a slider member 1101 connected to the proximal support 11, a first rotation member 1102 rotatably connected to the proximal support 11 around the first axis A1, and a second rotation member 1103 rotatably connected to the proximal support 11 around the second axis A2.

In an example embodiment, the slider member 1101 may be disposed on an outer surface of the proximal support 11. For example, the slider member 1101 may be disposed on the proximal support 11 to be positioned on the side of the user (e.g., the side of the user illustrated in FIG. 2B) based on a state in which the motion assist apparatus 10 is being worn on the body of the user. The slider member 1101 may guide a motion of the connector 130 to be described later. A description of the guiding is provided later.

In an example embodiment, the first rotation member 1102 may be rotatably connected to the slider member 1101 around the first axis A1. For example, the first rotation member 1102 may be disposed on an outer surface of the slider member 1101 on which a sliding surface 1101a, to be described later, is formed.

In an example embodiment, the second rotation member 1103 may be connected to the first rotation member 1102. For example, the second rotation member 1103 may be connected to the first rotation member 1102 to be opposite to the slider member 1101 with the first rotation member 1102 interposed therebetween. In an example embodiment, the second rotation member 1103 may be rotatably connected to first rotation member 1102 around the second axis A2. For example, the second rotation member 1103 may be connected to the first rotation member 1102 to perform a hinge motion around the second axis A2. In an example embodiment, the connector 130 may be connected to the second rotation member 1103.

In an example embodiment, the distal joint part 120 may be rotatably connected to the distal support 12. For example, the distal joint part 120 may rotate around a third axis A3 with respect to the distal support 12. In an example embodiment, the third axis A3 may be parallel to the second axis A2. In other words, the third axis A3 may be parallel to an axis that penetrates from the front to the rear of the user while the motion assist apparatus 10 is being worn on the body of the user. For example, the third axis A3 may be parallel to the adduction/abduction axis (e.g., the adduction/abduction axis X2 of FIG. 1B) of the hip joint. In an example embodiment, the distal joint part 120 may rotate around a fourth axis A4 with respect to the distal support 12. In an example embodiment, the fourth axis A4 may be parallel to the first axis A1. In other words, the fourth axis A4 may penetrate the body of the user in the lateral direction (e.g., the x-axis direction of FIG. 2B) while the motion assist apparatus 10 is being worn on the body of the user. In an example embodiment, the fourth axis A4 may penetrate the thigh of the user. In this example, the fourth axis A4 may coincide with a flexion/extension axis of the thigh.

In an example embodiment, when the motion assist apparatus 10 assists the motion of the hip joint of the user, the distal joint part 120 may secure a degree of freedom of a motion of the distal support 12 according to the adduction/abduction motion of the hip joint by rotating with respect to the distal support 12 in response to the adduction/abduction motion of the hip joint. In an example embodiment, the distal joint part 120 may include a third rotation member 1201 and a receiving member 1202.

In an example embodiment, the third rotation member 1201 may be connected to the distal support 12. For example, the third rotation member 1201 may be disposed on the distal support 12 to be positioned on the side of the user. In an example embodiment, the third rotation member 1201 may rotate around the third axis A3 with respect to the distal support 12. For example, the third rotation member 1201 may be rotatably connected to the distal support 12 and may rotate around the third axis A3 in response to an adduction/abduction direction motion of the thigh of the user.

In an example embodiment, the receiving member 1202 may be connected to the third rotation member 1201. In an example embodiment, the connector 130 may be movably connected to the receiving member 1202 in a first direction D1. In an example embodiment, the first direction D1 may be a direction perpendicular to the second axis A2 and the third axis A3. For example, based on the state of the motion assist apparatus 10 of FIG. 2B, the first direction D1 may be parallel to a z-axis. In an example embodiment, the receiving member 1202 may include a guide space 1202S formed in the first direction D1, and at least a portion of the connector 130 may be inserted into the guide space 1202S and slide in the guide space 1202S in the first direction D1.

In an example embodiment, the connector 130 may connect the proximal joint part 110 and the distal joint part 120. The connector 130 may move the distal support 12 relative to the proximal support 11 while the proximal support 11 and the distal support 12 are being connected. For example, the connector 130 may move the distal support 12 with respect to the proximal support 11 in response to the motion of the hip joint and implement a gait assist motion of the motion assist apparatus 10.

In an example embodiment, the connector 130 may operate according to a rotational motion of the proximal joint part 110 with respect to the proximal support 11 and move the distal support 12 with respect to the proximal support 11. For example, the proximal joint part 110 may rotate the connector 130 to adapt to the motion of the hip joint of the user through respective rotational motions of the first rotation member 1102 and the second rotation member 1103. In this example, since the connector 130 may be connected to the proximal support 11 through the first rotation member 1102 and the second rotation member 1103, the connector 130 may rotate around the first axis A1 or the second axis A2 according to the respective rotational motions of the first rotation member 1102 and the second rotation member 1103. In other words, the connector 130 may be rotated by the first rotation member 1102 around the first axis A1 in response to the flexion/extension motion of the hip joint of the user or may be rotated by the second rotation member 1103 around the second axis A2 in response to the adduction/abduction motion of the hip joint of the user. In an example embodiment, according to a rotational motion of the connector 130 around the first axis A1, a distal part of the body of the user (e.g., a thigh) supported by the distal support 12 may move according to the flexion/extension motion of the hip joint. In an example embodiment, according to a rotational motion of the connector 130 around the second axis A2, the distal part of the body of the user supported by the distal support 12 may move according to the adduction/abduction motion of the hip joint.

In an example embodiment, the connector 130 may include an elastic body. Since a torque needed according to an angle of the hip joint and a rotation of the hip joint matches a characteristic of the elastic body, a rotational motion of the hip joint may be assisted through the characteristic of the elastic body. For example, when the hip joint rotates in an adduction direction, the elastic body may assist the motion of the hip joint by bending in the adduction direction to generate a torque in an abduction direction. However, the elastic body is merely an example, and examples are not limited thereto. In an example embodiment, the connector 130 may adjust an elasticity coefficient by replacing the elastic body with another material or adding another material according to a weight or a gait speed of the user.

In an example embodiment, the motion assist apparatus 10 may prevent the connector 130 from excessively rotating with respect to the proximal joint part 110 during the rotational motion around the second axis A2, for example, a rotational motion according to an adduction motion of the hip joint. In an example embodiment, when the proximal joint part 110 rotates by an angle greater than or equal to a set angle, the connector 130 may bend in the adduction direction of the hip joint and generate the torque in the abduction direction. In an example embodiment, when the hip joint moves in the abduction direction, the connector 130 has a degree of freedom so that a motion of the user may not be interfered with, and the user may avoid any discomfort.

In an example embodiment, referring to FIG. 4, the slider member 1101 may include the sliding surface 1101a formed on the outer surface on which the first rotation member 1102 is disposed, and the connector 130 may include a set angle, for example, a slider 1301 that is in contact with the sliding surface 1101a while the user is standing upright as illustrated in FIG. 2A. In an example embodiment, the sliding surface 1101a may be formed in a peripheral region of the first rotation member 1102. Based on a state in which the slider 1301 is in contact with the sliding surface 1101a, for example, a state in which the user is standing upright, the slider 1301 may guide the rotational motion of the connector 130 around the first axis A1 while rotating around the first axis A1 along the sliding surface 1101a. In an example embodiment, the sliding surface 1101a may be concavely formed in a direction (e.g., a −y-axis direction of FIG. 3) opposite to the surface on which the first rotation member 1102 is disposed. However, this is merely an example, and the shape of the sliding surface 1101a is not limited thereto. In an example embodiment, the slider 1301 may be formed to protrude from an outer surface of the connector 130 so as to contact the sliding surface 1101a. In an example embodiment, the slider 1301 may be in point-contact with the sliding surface 1101a. For example, the slider 1301 may be formed in a hemisphere shape. According to this structure, when the slider 1301 is in contact with the sliding surface 1101a to limit the rotational motion of the connector 130 around the second axis A2, decreasing a contact area of the slider 1301 and the sliding surface 1101a may minimize frictional force generated during the rotation of the connector 130 around the first axis A1. Accordingly, it may be possible to limit the rotational motion of the connector 130 around the second axis A2 and to reduce an interference effect caused by the rotation of the connector 130 around the first axis A1.

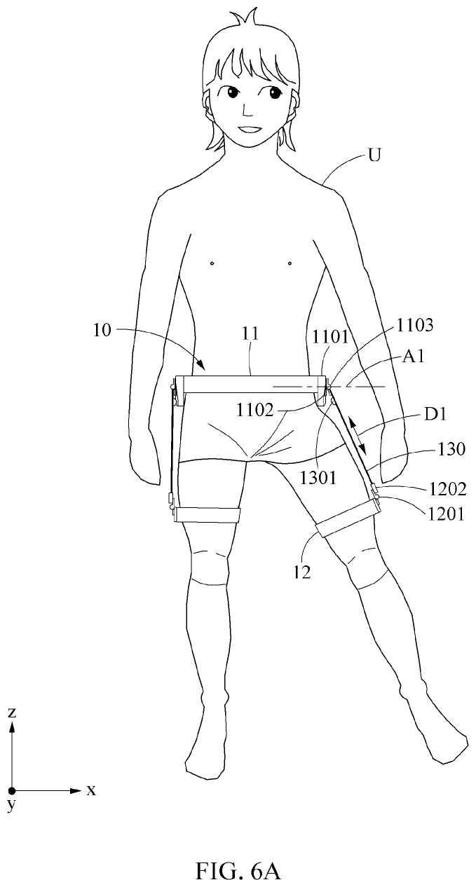

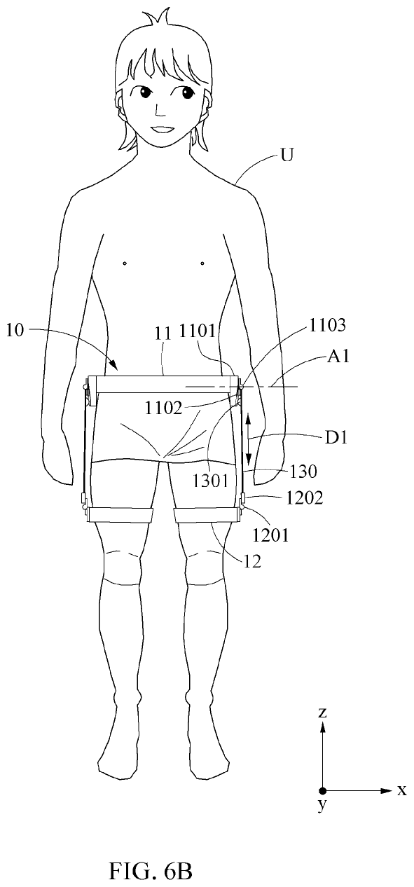

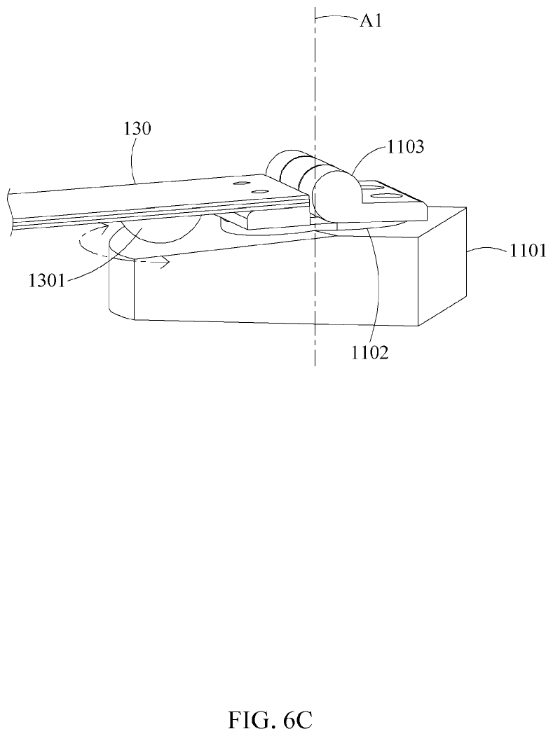

Hereinafter, a process in which the motion assist apparatus 10 assists a gait cycle of the user is described with reference to FIGS. 6A through 6C. Hereinafter, unless otherwise stated, it may be understood that the motion assist apparatus 10 operates according to the motion of the hip joint of the user.

FIG. 6A illustrates a motion of a motion assist apparatus according to an abduction motion of a hip joint in an example embodiment, FIG. 6B illustrates a motion of a motion assist apparatus according to an adduction motion of a hip joint in an example embodiment, and FIG. 6C illustrates a motion of a motion assist apparatus according to a flexion/extension motion of a hip joint in the state of FIG. 6B.

Referring to FIGS. 6A and 6B, in an example embodiment, when a hip joint of a user rotates in an adduction/abduction direction, the motion assist apparatus 10 may operate according to a motion of the hip joint through a rotational motion of the second rotation member 1103 around the second axis A2 and a rotational motion of the third rotation member 1201 around the third axis A3. In an example embodiment, since the connector 130 may rotate around the second axis A2 with respect to the proximal support 11 through the second rotation member 1103 and rotate around the third axis A3 with respect to the distal support 12 through the third rotation member 1201, during an adduction/abduction motion of the hip joint, the distal support 12 may change its position with respect to the proximal support 11 to adapt to the adduction/abduction motion of the hip joint through the rotational motions of the connector 130 around the second axis A2 and the third axis A3. In other words, a distal part, for example, a thigh of the user, supported by the distal support 12 may perform an adduction/abduction motion with respect to a proximal part, for example, a waist of the user, supported by the proximal support 11.

In an example embodiment, when the user is standing upright according to the adduction motion of the hip joint as illustrated in FIG. 6B, the connector 130 may be in contact with a sliding member of the proximal joint part 110 through the slider 1301 and may be prevented from rotating by an angle greater or equal to a set angle around the second axis A2. In other words, when the proximal joint part 110 rotates by the angle greater than or equal to the set angle, the motion assist apparatus 10 may cause the connector 130 to bend and generate a torque in an abduction direction by producing interference between the connector 130 and the proximal joint part 110 through contact between the slider 1301 and the sliding member. For example, the motion assist apparatus 10 may effectively prevent the user from losing balance and falling down by limiting an adduction angle. During an abduction motion, the motion assist apparatus 10 may assign a degree of freedom in the abduction direction so that the motion of the user may not be interfered with and the user may avoid any discomfort.

In an example embodiment, because the motion assist apparatus 10 may implement rotational motions around the second axis A2 and the third axis A3, a rotational motion between the distal support 12 and the connector 130 around the third axis A3 may be implemented even if a rotation in the adduction direction around the second axis A2 is limited while the user is standing upright. Accordingly, a degree of freedom for a motion of a distal part of a body of the user supported by the distal support 12 may be secured, and thus, the user wearing the motion assist apparatus 10 may feel less discomfort.

In an example embodiment, the motion assist apparatus 10 may be configured to allow the connector 130 to be movably connected to the receiving member 1202 in the first direction D1, and accordingly, a relative distance between the distal support 12 and the proximal support 11, for example a relative distance in the first direction D1, may change within a set range. In an example embodiment, because the proximal support 11 and the distal support 12 are fixed to the proximal part and the distal part of the body of the user, respectively, to assist an exercise motion of the user, a change in the relative distance between the distal support 12 and the proximal support 11 in the first direction D1 may occur, and accordingly, a free gait cycle of the user may be implemented.

Referring to FIG. 6C, in an example embodiment, the motion assist apparatus 10 may operate according to a flexion/extension motion of a hip joint. The motion assist apparatus 10 may rotate the distal support 12 around the first axis A1 with respect to the proximal support 11 through a rotational motion of the first rotation member 1102 around the first axis A1. In an example embodiment, the motion assist apparatus 10 may simultaneously perform motions according to the adduction/abduction motion and the flexion/extension motion of the hip joint of the user by rotating the distal support 12 around the first axis A1, the second axis A2, and the third axis A3 with respect to the proximal support 11, thereby implementing a gait assist motion to assist a gait of the user more naturally.

In an example embodiment, as illustrated in FIGS. 6B and 6C, in a state in which a rotational motion of the motion assist apparatus 10 around the second axis A2 is limited, for example, a state in which the connector 130 is in contact with the sliding surface 1101a of the proximal joint part 110 through the slider 1301, the connector 130 may stably implement the flexion/extension motion of the hip joint around the first axis A1 through a sliding motion of the slider 1301 with respect to the sliding surface 1101a.

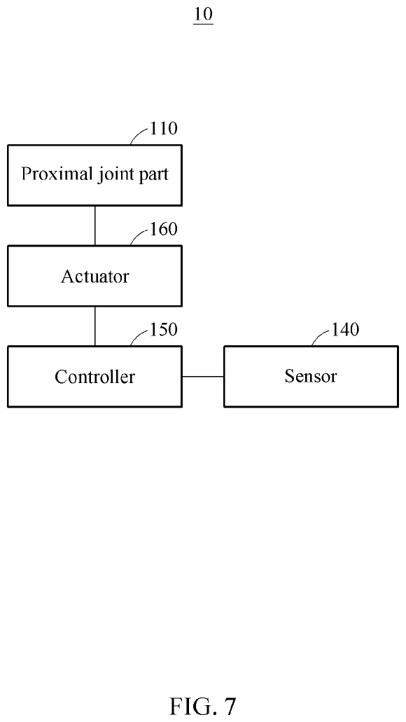

FIG. 7 is a block diagram illustrating a motion mechanism of a motion assist apparatus according to an example embodiment.

Referring to FIG. 7, according to an example embodiment, the motion assist apparatus 10 may include a sensor 140, a controller 150, and an actuator 160. According to an example embodiment, it may be understood that the motion assist apparatus 10 may include the configurations described with reference to FIGS. 2A through 6C. In an example embodiment, the motion assist apparatus 10 may sense information about a body, a gait cycle, and the like, of a user, to be optimized for a physical condition and assist a motion of that individual user. For example, the motion assist apparatus 10 may effectively assist the gait cycle of the user by recognizing the gait cycle of the user and selectively providing power needed for the gait cycle of the user.

In an example embodiment, the sensor 140 may sense an exercise motion of the user. For example, the sensor 140 may sense the gait cycle of the user. In an example embodiment, the sensor 140 may include an inertia sensor, a position detection sensor, and the like, or sense an exercise motion intended by the user by sensing force applied to each part according to the gait cycle of the user.

In an example embodiment, the actuator 160 may provide power for a motion of the motion assist apparatus 10. In an example embodiment, the actuator 160 may provide power for each rotational motion of the motion assist apparatus 10. In an example embodiment, the actuator 160 may provide power for a rotational motion of the proximal joint part 110. For example, the actuator 160 may provide power such that the first rotation member 1102 may rotate around the first axis A1 or provide power such that the second rotation member 1103 may rotate around the second axis A2. The actuator 160 may provide power for a rotational motion of the distal joint part 120. For example, the actuator 160 may provide power such that the third rotation member 1201 may rotate around the third axis A3. In an example embodiment, the motion assist apparatus 10 may include one or more of actuators 160. In an example embodiment, the actuator 160 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an example embodiment, the controller 150 may control an operation of the actuator 160 based on information sensed by the sensor 140. In an example embodiment, the controller 150 may selectively operate the actuator 160 to assist a motion of the user, for example, a motion of a hip joint of the user intended by the user, sensed by the sensor 140. In an example embodiment, the controller 150 may control the operation of the actuator 160 such that the proximal joint part 110 and the distal joint part 120 may rotate in response to a recognized gait cycle of the user.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and/or equivalents of the claims are within the scope of the following claims.

What is claimed is:

1. A motion assist apparatus comprising:
a proximal support configured to support a proximal part of a user;
a distal support configured to support a distal part of the user;
a proximal joint part rotatably connected to the proximal support around a first axis and a second axis perpendicular to the first axis;
a distal joint part rotatably connected to the distal support around a third axis parallel to the second axis; and
a connector configured to connect the proximal joint part and the distal joint part and movably connected to the distal joint part in a first direction perpendicular to the second axis and the third axis.

2. The motion assist apparatus of claim 1, wherein
the proximal joint part comprises:
a slider member connected to the proximal support;
a first rotation member disposed on the slider member and rotatably connected to the slider member around the first axis; and
a second rotation member configured to connect the first rotation member and the connector such that the connector is rotatable around the second axis with respect to the first rotation member, and
the slider member comprises a sliding surface formed on a surface on which the first rotation member is disposed and configured to guide a rotational motion of the connector with respect to the proximal joint part.

3. The motion assist apparatus of claim 2, wherein
the connector comprises a slider to be in contact with the sliding surface, and
the slider is configured to guide a first rotational motion of the connector around the first axis and a second rotational motion of the connector around the second axis while being in contact with the sliding surface.

4. The motion assist apparatus of claim 2, wherein
the slider is configured to limit a rotation angle of the connector such that the connector is in contact with the sliding surface and unable to rotate by an angle greater than or equal to a set angle while the connector is rotating around the second axis with respect to the proximal joint part, and
the connector is configured to generate a torque in a direction opposite to a rotational direction of the connector in response to rotating by the angle greater than or equal to the set angle.

5. The motion assist apparatus of claim 3, wherein
the sliding surface is formed such that a surface of the slider member is concave in a direction opposite to a surface on which the first rotation member is disposed, and
the slider is in point-contact with the sliding surface.

6. The motion assist apparatus of claim 1, wherein
the connector is configured to assign a degree of freedom in an abduction direction of the proximal part in response to a proximal part of the user moving in the abduction direction.

7. The motion assist apparatus of claim 1, wherein the distal joint part comprises:
a third rotation member rotatably connected to the distal support around the third axis; and
a receiving member connected to the third rotation member and connected to the connector such that the connector is movable in the first direction.

8. The motion assist apparatus of claim 7, wherein
the receiving member comprises a guide space formed in the first direction, and
at least a portion of the connector is inserted into the guide space and is slidable in the first direction in the guide space.

9. The motion assist apparatus of claim 1, wherein
the proximal support is disposed on a hip joint part of the user,
the distal support is disposed on a thigh of the user, and
the first axis penetrates a hip joint of the user based on a state in which the user is viewed from a side.

10. The motion assist apparatus of claim 2, wherein
the first rotation member is configured to rotate around the first axis in response to a flexion motion and an extension motion of a hip joint of the user, and
the second rotation member is configured to rotate around the second axis in response to an adduction motion and an abduction motion of the hip joint of the user.

11. The motion assist apparatus of claim 1, wherein the connector is formed of an elastic body.

12. The motion assist apparatus of claim 1, further comprising:
a sensor configured to sense a gait cycle of the user;
an actuator configured to supply power such that the proximal joint part rotates with respect to the proximal support; and
a controller configured to control an operation of the actuator based on information sensed by the sensor.

13. A motion assist apparatus, comprising:
a proximal support worn around a waist of a user;
a distal support worn around a thigh of the user;
a proximal joint part connected to the proximal support and configured to rotate in response to a motion of a hip joint of the user;
a distal joint part rotatably connected to the distal support; and
a connector rotatably connected to the proximal joint part and movably connected to the distal joint part in a longitudinal direction.

14. The motion assist apparatus of claim 13, wherein the proximal joint part is rotatably connected to the proximal support in an adduction direction or an abduction direction with respect to the hip joint of the user.

15. The motion assist apparatus of claim 13, wherein the proximal joint part is rotatably connected to the proximal support in a flexion direction or an extension direction with respect to the hip joint of the user.
